(19) United States
(12) Patent Application Publication
(10) Pub. No.: US 2022/0267646 A1
(43) Pub. Date: Aug. 25, 2022

(54) ADHESIVE FILM, COMPOSITE FILM, ALL-SOLID-STATE BATTERY AND METHOD FOR PRODUCING COMPOSITE FILM

(71) Applicant: NEION Film Coatings Corp., Higashiosaka-shi, Osaka (JP)

(72) Inventor: Takeshi YAMADA, Higashiosaka-shi, Osaka (JP)

(21) Appl. No.: 17/050,217

(22) PCT Filed: Sep. 27, 2019
(86) PCT No.: PCT/JP2019/038073

§ 371 Date: Oct. 23, 2020

(30) Foreign Application Priority Data
Sep. 28, 2018 (JP) 2018-185978

(51) Int. Cl. C09J 7/10; C09J 11/04; C08J 5/18; C09J 7/29; C08K 9/10; C08K 7/16; C08K 3/08; H01M 50/451; H01M 50/414; H01M 50/443; H01M 10/0585; H01M 10/0562

(52) U.S. Cl. CPC C09J 7/10; C09J 11/04; C08J 5/18; C09J 7/29; C08K 9/10; C08K 7/16; C08K 3/08; H01M 50/451; H01M 50/414; H01M 50/443; H01M 10/0585; H01M 10/0562; C09J 2433/00; C09J 2400/163; C08J 2333/08; C08K 2003/0862; C08K 2003/0831; H01M 2300/0097

(57) ABSTRACT

A composite film 10 according to the present invention is provided with: a resin film 1 which is formed of a cured product of a photocurable adhesive composition; and solid particles 3 which are affixed, in the form of a single layer, to the resin film 1, while having edges thereof exposed from one and the other main surfaces of the resin film 1. The resin film 1 is formed by irradiating an adhesive layer 1a in a semi-cured state with light 13, said adhesive layer 1a being formed of the adhesive composition.

### CROSS REFERENCE TO RELATED APPLICATIONS

This application is a national stage application, filed under 35 U. S.C. § 371, of International Application No. PCT/JP2019/038073, filed Sep. 27, 2019, which claims priority to Japanese Application No. 2018-185978, filed Sep. 28, 2018, the contents of both of which as are hereby incorporated by reference in their entirety.

### BACKGROUND

### Technical Field

The technology disclosed herein relates to techniques of forming a resin film to which solid particles are fixed.

### Description of Related Art

Techniques of fixing solid particles to a resin film are used in various fields. For example, a composite film in which solid electrolyte particles are fixed to a resin film can be used in lithium-ion all-solid-state batteries, lithium-air batteries, etc., which are promising technologies because of their theoretical energy densities higher than those of conventional lithium ion secondary batteries (Japanese Unexamined Patent Publication (Japanese Translation of PCT Application) No. 2017-509748). Such a composite film, which is also described in U.S. Pat. No. 4,977,007; Japanese Unexamined Patent Publication No. 2018-6297; and Japanese Unexamined Patent Publication No. 2017-216066, can simultaneously exhibit thermal stability attributed to the inorganic ion conductive material, and good flexibility and workability attributed to the contained resin.

### BRIEF SUMMARY

In the techniques described in Japanese Unexamined Patent Publication (Japanese Translation of PCT Application) No. 2017-509748 and Japanese Unexamined Patent Publication No. 2018-6297, a binder is applied to ion conductive particles, and dried, and thereafter, the resin is partially removed by etching so that the ion conductive particles are exposed from the resin film. However, in those techniques, the inclusion of the etching step increases the number of steps, leading to an increase in manufacturing cost, and difficulty in improving the efficiency of mass production.

In the technique described in U.S. Pat. No. 4,977,007, a resin such as silicone rubber containing solid electrolyte particles is applied to a base material, and thereafter, the resultant structure is passed through between rollers to form a film including the resin film and the solid electrolyte particles. In that technique, extra solid electrolyte particles are removed during the formation of the film, likely leading to a waste of the material. In addition, solid electrolyte particles cannot be reliably fixed to some base materials, and may come off.

In the technique described in Japanese Unexamined Patent Publication No. 2017-216066, resin particles and solid electrolyte particles are arranged in a single layer in the same plane, and are heated at a temperature higher than or equal to the melting point of the resin, to form a composite film in which the solid electrolyte particles are exposed at the opposite surfaces of the resin film. However, in that technique, a space is likely to remain between solid electrolyte particles, and therefore, in the case where that composite film is used in a secondary ion battery, the secondary ion battery may fail to exhibit reliable performance. In addition, a thermoplastic resin is used, and therefore, the composite film may be deformed and may not maintain its shape at high temperature.

With the above problems in mind, it is an object of the present invention to provide a composite film that includes solid particles and a resin film, and that can be produced at low cost and is easy to handle.

An adhesive film disclosed herein is a photocurable adhesive film that is for fixing solid particles and that includes an adhesive layer containing an adhesive composition in a first state, i.e., a semi-cured state, and does not have a base material, wherein the storage modulus of the adhesive layer, when irradiated with light, increases from that in the semi-cured state, and the adhesive layer has a film thickness t of 0.45 D or less, where D represents the average particle size of the solid particles.

A composite film disclosed herein includes a resin film formed of a cured product of a photocurable pressure sensitive adhesive composition, and a single layer of solid particles fixed to the resin film with end portions thereof exposed from a first and a second surface of the resin film. The resin film is formed by irradiating a semi-cured adhesive layer formed of the adhesive composition with light.

A method for producing a composite film disclosed herein includes a step of distributing and placing a single layer of solid particles on a semi-cured adhesive layer included in a photocurable adhesive film, the adhesive layer containing an adhesive composition, a step of pushing the solid particles into the adhesive layer by applying pressure and heat thereto with opposite surfaces of the adhesive layer covered by a first and a second release liner, and a step of curing the adhesive layer by irradiating the adhesive layer with light, to form a resin film to which the solid particles are fixed with end portions of the solid particles exposed from one and the other main surfaces of the adhesive layer. A film thickness t of the adhesive layer during the step of distributing the solid particles is 0.45 D or less, where D represents the average particle size of the solid particles.

The composite film disclosed herein can be produced at low cost, and is less likely to deform due to shrinkage after the production, and therefore, is easy to handle. The adhesive film disclosed herein is preferably used in production of the composite film.

### BRIEF DESCRIPTION OF THE FIGURES

FIG. 1 is a cross-sectional view schematically showing a structure of a composite film according to an embodiment of the present invention.

FIG. 2 is a cross-sectional view showing an example all-solid-state battery produced using a composite film according to an embodiment of the present invention.

FIG. 3 is a cross-sectional view showing a structure of an adhesive film used in production of the composition film of FIG. 1.

FIGS. 4(a)-4(d) are cross-sectional views showing a production method for a composite film according to an embodiment of the present invention.

FIG. 5 is a photograph showing a main surface of an adhesive layer before hot pressing on which solid particles are distributed in Example 7.

FIG. 6 is a photograph showing a main surface of a biaxially-stretched polypropylene film (OPP film) on which solid particles are distributed in Comparative Example 2.

FIG. 7 is a photograph showing a composite film (left side) after hot pressing in Example 7, and a composite film (right side) after hot pressing in Comparative Example 1.

### DETAILED DESCRIPTION OF VARIOUS EMBODIMENTS

### Embodiments

-Structure of Composite Film-

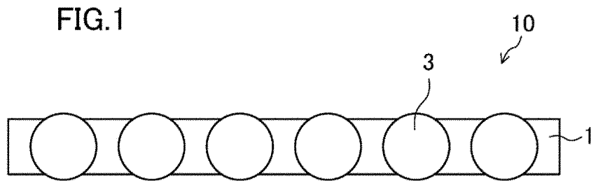

FIG. 1 is a cross-sectional view schematically showing a structure of a composite film according to an embodiment of the present invention. As shown in FIG. 1, the composite film 10 of this embodiment includes a resin film 1 that is formed of a cured product of a photocurable pressure sensitive adhesive composition, and a single layer of solid particles 3 that are fixed to the resin film 1 with end portions thereof exposed from a first and a second surface of the resin film 1. As described below, the resin film 1 is formed by irradiating, with light, an adhesive layer formed of an adhesive composition in a first state, i.e., a semi-cured state. As used herein, the term “semi-cured state” with respect to a material refers to a state in which the material has a viscosity that allows the material to maintain its film shape when applied to any base material, and the material can be further cured, in a subsequent step, into a second state, i.e., a cured state.

The type of the solid particle 3 is not particularly limited. For example, the solid particle 3 may be a solid electrolyte particle having ion conductivity, an electrically conductive particle, or an insulating particle.

The solid particle 3 may, for example, be a sulfide solid electrolyte particle or an oxide solid electrolyte particle. Examples of the oxide solid electrolyte include γ-LiPO₄ type oxides, antifluorite type oxides, NASICON type oxides, perovskite type oxides, and garnet type oxides. Examples of NASICON type oxides include Li₁₊ₓMₓTi₂₋ₓ(PO₄)₃ (where M represents at least one element selected from Al and rare-earth elements, and x represents 0.1-1.9). Examples of perovskite type oxides include La_{2/3-x}Li3ₓTiO₃. Examples of garnet type oxides include Li₇La₃Zr₂O₁₂. Crystalline oxide solid electrolyte particles obtained by performing substitution and/or doping with an element on the basic crystalline structure thereof can be used for the purpose of increasing ion conductivity, for the purpose of increasing chemical stability, and in terms of increasing workability. Preferable examples of NASICON type oxides include Li_{1.3}Al_{0.3}Ti_{1.7}(PO₄)₃. Preferable examples of garnet type oxides include Li₇La₃Zr₂O₁₂, element-substituted Li_{6.25}Al_{0.25}La₃Zr₂O₁₂, Li₇La₃Zr₂₋ₓNbₓO₁₂ (0<X<0.95), and Li₇La₃Zr₂₋ₓTaₓO₁₂ (0<X<0.95).

By using the composite film 10 to which the above solid electrolyte particles are fixed, an all-solid-state battery having flexibility can be obtained.

In the case where an electrically conductive particle is used as the solid particle 3, the composite film 10 may, for example, be used as an anisotropic electrically conductive film that electrically couples electronic components together. As the electrically conductive particle, a metal particle or a metal-coated particle can be used.

Examples of a material for the metal particle include nickel, cobalt, silver, copper, gold, palladium, and solder. These may be used alone or in combination.

The metal-coated particle is not particularly limited as long as it is a particle made of a resin or the like the surface of which is coated with a metal film, and may be suitably selected, depending on the purpose. For example, the surface of the resin particle may be coated with at least any one of the metals nickel, silver, solder, copper, gold, and palladium. The use of the particle coated with gold or silver allows a reduction in the electrical resistance in the film thickness direction of the composite film 10.

As the adhesive agent for forming the resin film 1, one or a mixture of two or more selected from acrylic adhesive agents, silicone adhesive agents, urethane adhesive agents, polyester adhesive agents, and rubber adhesive agents, is used. As the resin film 1 is used as a solid electrolyte film or an anisotropic electrically conductive film, the resin film 1 preferably has insulating properties.

The average particle size (average primary particle size) of the solid particles 3 is not particularly limited. The film thickness of the resin film 1 is not particularly limited as long as it is smaller than the average particle size of the solid particles 3. Note that the average particle size of the solid particles 3 is based on measurement performed by a commercially available laser diffraction particle size distribution meter. In the case where the solid particles 3 are unshaped, the particle size of the solid particles 3 is represented by a biaxial average size.

In the case where the solid particles 3 are a solid electrolyte particle, the average particle size of the solid particles 3 is often 2-100 μm. If the average particle size is less than 2 μm, the resin film 1 for fixing the solid particles 3 is also very thin, and therefore, it is difficult to secure the strength of the resin film 1, and it is also difficult to obtain, with high precision, a uniform film thickness of the adhesive layer of the adhesive film used for forming the resin film 1. In the case where the solid particles 3 are an electrically conductive particle for an anisotropic electrically conductive film, the average particle size of the solid particles 3 is also often 2-100 μm. If the average particle size of the solid particles 3 is 100 μm or less, the film thickness of the composite film 10 can be reduced, leading to a reduction in the thickness and size of an electronic apparatus in which the composite film 10 is used.

The film thickness of the resin film 1 is less than the average particle size of the solid particles 3. In order to more reliably secure the exposure of the solid particles 3 from the opposite surfaces of the resin film 1, the film thickness of the resin film 1 may be 0.8 D or less, where D represents the average particle size of the solid particles 3. In addition, if the film thickness of the resin film 1 is 0.2 D or more, the solid particles 3 can be less likely to come off from the resin film 1.

The solid particle 3 may be in the shape of a sphere as shown in FIG. 1, irrespective of the application of the composite film 10. Alternatively, the solid particle 3 may have any shape, such as an ellipsoid or an indefinite shape having a roughness on the surface thereof as long as opposite ends (an upper and a lower end in FIG. 1) of the solid particle 3 are exposed from the main surfaces of the resin film 1. The solid particle 3 is preferably spherical or approximately spherical, because in this case the solid particle 3 can be easily designed to be more reliably exposed from the resin film 1 than in the case where variations in particle size are small. The particle size of the solid particles 3 may fall within the range of ±10% of the average particle size.

In the composite film 10 of this embodiment, the solid particles 3 are buried in the resin film 1 with the solid particles 3 arranged in a single layer. This allows ion conduction or electron transfer without through particle-to-particle contact, and therefore, an increase in impedance can be inhibited.

In the composite film 10 of this embodiment, the value of (the total of the projection areas of the solid particles 3)/(the area of the resin film 1 in the region where the solid particles 3 are fixed) as viewed from above (this value is hereinafter referred to as a “packing density of solid particles”) may be 30-80%. As used herein, the term “area of the resin film 1 in the region where the solid particles 3 are fixed” means the area of the entire resin film 1 including the areas of the solid particles 3 in the region. The solid particles 3 ideally take a two-dimensional close-packed structure in order to produce an all-solid-state battery having a great current density or form an anisotropic electrically conductive film having a low resistance. However, for the resin film 1 of this embodiment, the production method therefor makes it difficult to obtain a close-packed structure. Therefore, the packing density of the solid particles 3 is 80% or less unless a special process is performed. If a production method described below is used, the packing density of the solid particles 3 can be 30% or more, more preferably 55% or more.

The resin film 1 is cured by irradiation with light, such as visible light or ultraviolet light. In the resin film 1, a photopolymerization initiator and a reaction product thereof, and a crosslinking agent, that have been used as a material and contained in the adhesive layer, may be left.

In the composite film 10 of this embodiment, the resin film 1 may have a storage modulus of 1×10⁵ to 5×10⁹ Pa or 1×10⁶ to 5×10⁸ Pa, at 1 Hz at 23° C. Because the storage modulus is 1×10⁵ Pa or more, a shrinkage of the film caused by residual stress is less likely to occur, and the composite film 10 is easy to handle.

The composite film 10 of this embodiment also has flexibility, and therefore, even when the composite film 10 is bent, damage to the composite film 10 is less likely to occur. Therefore, the composite film 10 can, for example, be used in a film-type all-solid-state battery.

Note that the resin film 1 may or may not remain tacky. The resin film 1 may have a value of substantially 0 N/m² or more as measured by a probe tack test. In the case where the resin film 1 does not have tackiness (i.e., the value measured by a probe tack test is substantially 0 N/cm²), when the composite film 10 is folded in use, the composition film 10 will not stick to itself, and therefore, the composite film 10 is easy to handle.

-Structure of All-Solid-State Battery-

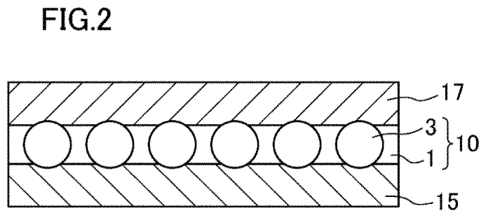

FIG. 2 is a cross-sectional view showing an example all-solid-state battery produced using a composite film according to an embodiment of the present invention. The all-solid-state battery of this embodiment is a lithium ion secondary battery, or alternatively, may be other all-solid-state batteries, such as a lithium ion primary battery.

The all-solid-state battery of this embodiment includes a positive electrode layer 15, a composite film 10 to which a plurality of solid particles 3 which are a solid electrolyte particle are fixed, and a negative electrode layer 17, which are stacked in this order. The positive electrode layer 15 is in contact with the solid particles 3 exposed at a first surface of the composite film 10, and the negative electrode layer 17 is in contact with the solid particles 3 exposed at a second surface of the composite film 10. Note that the first and second surfaces may be reversed.

The all-solid-state battery of this embodiment is produced by a method similar to a known technique. For example, the all-solid-state battery is produced by forming a stack of the positive electrode layer 15, the composite film 10, and the negative electrode layer 17 into the shape of a cylinder, coin, rectangle, or film, or any other shapes. In the case of the film-type all-solid-state battery, the positive electrode layer 15 and the negative electrode layer 17 which are also in the shape of a film may be suitably folded into a layered product, which may then be loaded into a container. Alternatively, a plurality of units each including the positive electrode layer 15, the composite film 10, and the negative electrode layer 17 may be connected together in series.

<Positive Electrode Layer>

The structure of the positive electrode layer 15 of this embodiment is not particularly limited. The materials and structure that are commonly used in all-solid-state batteries can be applied to the positive electrode layer 15 of this embodiment. The positive electrode layer 15 can, for example, be obtained by forming a positive electrode active substance layer containing a positive electrode active substance on the surface of a charge collector made of aluminum foil or the like.

The positive electrode active substance is not particularly limited as long as it can reversibly release and absorb/store lithium ions, and has a high electrical conductivity to easily transport electrons. Known solid positive electrode active substances can be used. Examples of the positive electrode active substance include composite oxides such as lithium cobalt oxide (LiCoO₂), lithium nickel oxide (LiNiO₂), lithium manganese oxide (LiMn₂O₄), solid solution oxides (Li₂MnO₃—LiMO₂ (M=Co, Ni, etc.)), lithium-manganese-nickel oxide (LiNi_{1/3}Mn_{1/3}Co_{1/3}O₂), and olivine-type lithium phosphorus oxide (LiFePO₄); electrically conductive polymers such as polyaniline and polypyrrole; sulfides such as Li₂S, CuS, Li—Cu—S compounds, TiS₂, FeS, MoS₂, and Li—Mo—S compounds; and a mixture of sulfur and carbon. These positive electrode active substances may be used alone or in combination.

The positive electrode active substance layer may contain a binder having the function of binding positive electrode active substances together and a positive electrode active substance and a charge collector together. The binder is not particularly limited as long as it is a commonly used binder for all-solid-state batteries. The binder may, for example, be one or a mixture of two or more selected from polyvinyl alcohol, polyacrylic acid, carboxymethyl cellulose, polytetrafluoroethylene, polyvinylidene fluoride, styrene-butadiene rubbers, polyimides, etc.

The positive electrode active substance layer may contain a conductive agent in terms of improving the electrical conductivity of the positive electrode layer 15. The conductive agent is not particularly limited as long as it is a commonly used conductive agent for all-solid-state batteries. Examples of the conductive agent include carbon blacks such as acetylene black and ketjen black, and carbon materials such as carbon fibers, graphite powders, and carbon nanotubes.

The positive electrode layer 15 may contain a solid electrolyte material. As the solid electrolyte material, materials similar to those for the solid particles 3 can be used.

<Negative Electrode Layer>

The materials and structure that are commonly used for all-solid-state batteries can be applied to the negative electrode layer 17. For example, the negative electrode layer 17 can, for example, be obtained by forming a negative electrode active substance layer containing a negative electrode active substance on the surface of a charge collector made of copper or the like. The thickness and density of the negative electrode active substance layer are suitably determined, depending on the use and application, etc., of the battery.

The negative electrode active substance is not particularly limited as long as it can reversibly release and absorb/store lithium ions, and has a high electrical conductivity. Known negative electrode active substances can be used. Examples of the negative electrode active substance include carbonaceous materials such as graphite, resinous coal, carbon fiber, activated carbon, hard carbon, and soft carbon, alloy-based materials mainly made of tin, a tin alloy, silicon, a silicon alloy, gallium, a gallium alloy, indium, an indium alloy, aluminum, an aluminum alloy, etc., electrically conductive polymers such as polyacenes, polyacetylene, and polypyrrole, the metal lithium, and lithium titanium composite oxides (e.g., Li₄Ti₅O₁₂). These negative electrode active substances may be used alone or in combination. The negative electrode active substance layer may contain a solid electrolyte material as a component in addition to the negative electrode active substance of this embodiment. The negative electrode active substance layer may also contain a binder, conductive agent, etc.

-Production Method for Composite Film-

<Double-sided Adhesive Film>

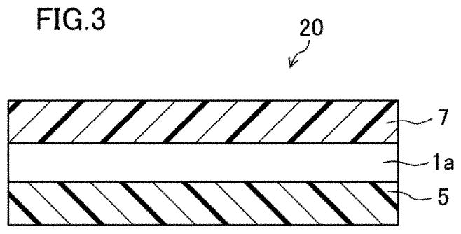

In production of the composite film 10 of this embodiment, a photocurable adhesive film 20 not having a base material is initially prepared. FIG. 3 is a cross-sectional view showing an example of the adhesive film 20 used in a production method according to an embodiment of the present invention. FIG. 3 is a schematic diagram, and therefore, the thickness of each member and the shape of particles are not limited to examples shown in FIG. 3.

The adhesive film 20 includes an adhesive layer 1a mainly formed of a semi-cured adhesive agent, a first release liner 5 covering a second surface (lower surface in FIG. 3) of the adhesive layer 1a, and a second release liner 7 covering a first surface (upper surface in FIG. 3) of the adhesive layer 1a. The adhesive layer 1a may not be formed on a base material. The adhesive layer 1a may be formed of a material whose storage modulus increases when the material is irradiated with light, so that the material is changed from a first state, i.e., the semi-cured state, to a second state. Note that the first and second surfaces may be reversed.

The film thickness of the adhesive layer 1a is not particularly limited. In the case where the adhesive layer 1a is used in production of the composite film 10 shown in FIG. 1, the film thickness of the adhesive layer 1a is preferably 0.45 D or less, where D represents the average particle size of the solid particles 3. If the film thickness of the adhesive layer 1a is 0.45 D or less, opposite ends of the solid particles 3 can be exposed from the resin film 1 after a hot pressing step described below. In addition, an extra portion of the adhesive layer 1a can be prevented from sticking out of a pressing machine. Furthermore, if the film thickness of the adhesive layer 1a is 0.35 D or less, opposite ends of the solid particles 3 can be reliably exposed from the resin film 1 after the hot pressing step even in the case where there are variations in the average particle size of the solid particles 3.

The release force of the first release liner 5 with respect to the adhesive layer 1a is greater than the release force of the second release liner 7 with respect to the adhesive layer 1a as measured under the same conditions. As a result, when the adhesive film 20 is used, the adhesive layer 1a can be easily released from the second release liner 7.

The adhesive agent for forming the adhesive layer 1a may be one that can be cured by ultraviolet light or visible light after being applied and dried and thereby formed into a film. The adhesive agent for forming the adhesive layer 1a may be a known adhesive agent, such as an acrylic adhesive agent, silicone adhesive agent, polyester adhesive agent, and rubber adhesive agent. The adhesive agent does not necessarily need to be of the two-step curable type. Alternatively, the adhesive agent may be one that can be dried into gel after being applied, and subsequently cured by light. In addition, maleimide may be added to the adhesive agent in order to adjust the storage modulus of the cured adhesive agent.

For example, the semi-cured adhesive layer 1a can be formed by applying, drying, and aging a thermosetting acrylic adhesive agent additionally containing a photopolymerization initiator. Alternatively, the semi-cured adhesive layer 1a can be formed by applying an acrylic adhesive agent additionally containing a first photopolymerization initiator that absorbs light having a first wavelength to generate radicals, and a second photopolymerization initiator that absorbs light having a second wavelength different from the first wavelength to generate radicals, and then irradiating the acrylic adhesive agent with light having the first wavelength. As the photopolymerization initiator, one or a mixture of two or more selected from known alkylphenone photopolymerization initiators, acylphosphine oxide photopolymerization initiators, intramolecular hydrogen extraction type photopolymerization initiators, oxime ester photopolymerization agents, and cation photopolymerization initiators, is used.

The adhesive layer 1a may also contain a known curing agent-derived component such as an isocyanate or epoxy. In the case where an acrylic adhesive agent is used, the storage modulus of the adhesive layer 1a can be increased by increasing the amount of a curing agent added within the range less than or equal to the equivalent point thereof.

The storage modulus (G′) of the adhesive layer 1a in the first state before light irradiation as measured at a frequency of 1 Hz at 120° C. is preferably 1×10² Pa to 1×10⁶ Pa, more preferably 1×10⁴ Pa to 1×10⁵ Pa. If the storage modulus is 1×10² Pa or more, the shape stability of the adhesive layer 1a before hot pressing can be improved. If the storage modulus is 1×10⁴ Pa or more, the shape stability of the adhesive layer 1a before hot pressing can be further improved. Meanwhile, if the storage modulus is 1×10⁶ Pa or less, the solid particles 3 can be easily pushed into the adhesive layer 1a (the resin film 1) in the hot pressing step, and therefore, the solid particles 3 can be easily exposed at the surface of the resin film 1 facing the first release liner 5. If the storage modulus is 1×10⁵ Pa or less, the solid particles 3 can be more reliably exposed from the surface of the resin film 1 facing the first release liner 5.

In the second state in which the adhesive layer 1a is cured into the resin film 1 by light irradiation following the hot pressing, the storage modulus of the adhesive layer 1a as measured at a frequency of 1 Hz at 23° C. is preferably greater than the storage modulus of the adhesive layer 1a in the first state before being cured with light as measured at a frequency of 1 Hz at 23° C. Specifically, the storage modulus in the second state as measured at a frequency of 1 Hz at 23° C. may be 1×10⁵ Pa to 5×10⁹ Pa, or 1×10⁶ Pa to 5×10⁸ Pa. After the formation of the resin film 1 by curing by light irradiation, if the storage modulus is 1×10⁵ Pa or more, the shrinkage of the composite film 10 due to residual stress of hot pressing can be reduced. If the storage modulus after curing is 1×10⁶ Pa or more, the shrinkage of the composite film 10 after hot pressing can be more effectively reduced, and therefore, the composite film 10 is easy to handle even in the case of scaling up, likely leading to facilitation of mass production.

Note that the resin film 1 has suitable flexibility, and therefore, can be applied to a film-type all-solid-state battery which is folded and layered, for example.

The adhesive layer 1a also has so-called tackiness. The adhesive layer 1a has a value of more than 0 N/cm² as measured by a probe tack test. In this case, when the solid particles 3 are distributed on the adhesive layer 1a in the hot pressing step, the solid particles 3 can be easily held on the adhesive layer 1a, resulting in an increase in the packing density of the solid particles 3. The value as measured by a probe tack test may be 1 N/cm² or more.

The base materials for the first release liner 5 and the second release liner 7 may both be a resin film made of polyethylene terephthalate (PET) or a polyolefin, or glassine or wood-free paper. The release surfaces of the first release liner 5 and the second release liner 7, which are attached to the adhesive layer 1a, may be subjected to a known release treatment, such as a silicone treatment or a fluorine treatment.

In order to produce the adhesive film 20, an adhesive agent is initially applied to the release surface of the first release liner 5 for heavy release using a known coater such that the adhesive agent subsequently has a predetermined film thickness after being dried, and is then dried to form a semi-cured the adhesive layer 1a. Next, the second release liner 7 for light release is attached to the exposed surface of the adhesive layer 1a to form an adhesive film, followed by aging for several days, whereby the adhesive film 20 can be formed. Note that instead of the above method, an adhesive agent may be applied to the release surface of the second release liner 7, and dried, and thereafter, the first release liner 5 may be attached thereto.

<Production of Composite Film 10>

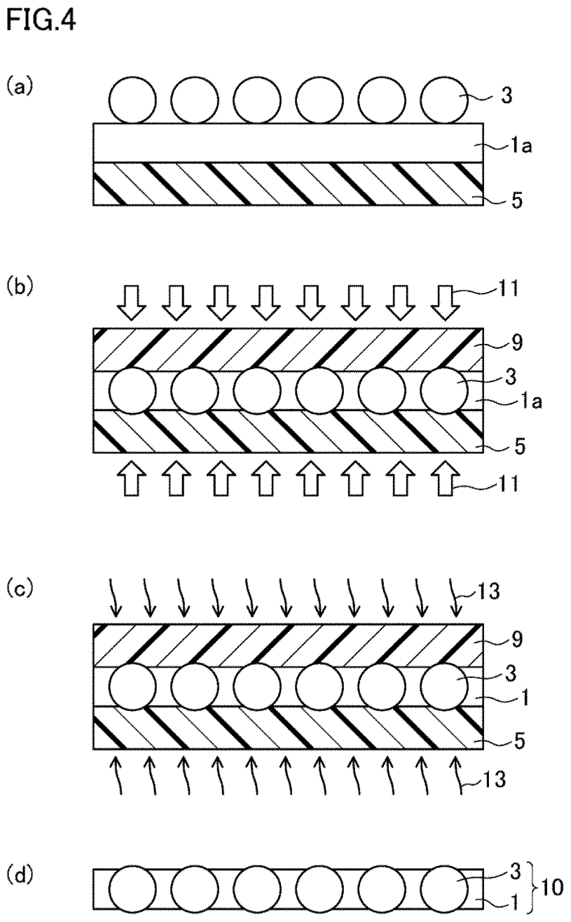

FIGS. 4(a)-4(d) are cross-sectional views showing a production method for a composite film according to an embodiment of the present invention. In the production method of this embodiment, a roll of the adhesive film 20 may be used, or a cut sheet of the adhesive film 20 may be used.

Initially, as shown in FIG. 4(a), the solid particles 3 are uniformly distributed and placed on the adhesive layer 1a after the second release liner 7 for light release has been removed from the adhesive film 20.

Next, as shown in FIG. 4(b), a third release liner 9 having a smaller release force with respect to the adhesive layer 1a than that of the first release liner 5 is attached to the surface of the adhesive layer 1a on which the solid particles 3 are placed, and thereafter, a pressure 11 is applied to the resultant structure from the opposite sides thereof, i.e., from the first release liner 5 and the third release liner 9, while heating the structure, by a hot pressing machine. As a result, the solid particles 3 are pushed into the adhesive layer 1a, and lower ends of the solid particles 3 stick out from the adhesive layer 1a and are brought into direct contact with the first release liner 5. As the third release liner 9, the second release liner 7 removed in the previous step may be used, or a release liner separately prepared may be used.

In this step (hot pressing step), because the film thickness of the adhesive layer 1a is 0.45 D or less, opposite ends of the solid particles 3 can be easily exposed from the resin film 1. In addition, the solid particles 3 are less likely to overlap as viewed from above, and therefore, the plurality of solid particles 3 can be easily arranged in a single layer. Note that if the film thickness of the adhesive layer 1a is excessively great relative to the particle sizes of the solid particles 3, the adhesive layer 1a is extended in a plane direction when a pressure is applied thereto, so that the density of the solid particles 3 per unit area of the resin film 1 decreases.

In this step, the heating temperature may, for example, be about 100-160° C., and the applied pressure 11 is about 1-5 MPa/cm². The duration of the hot pressing is, for example, 1 minute or longer, or may be about 10 minutes or shorter. If the processing duration is excessively long, the production efficiency decreases. Note that the temperature at which the hot pressing is performed may be suitably changed, depending on the type of an adhesive agent used, and is a temperature at which the adhesive layer is sufficiently softened.

Next, as shown in FIG. 4(c), the adhesive layer 1a, the first release liner 5, and the third release liner 9 are irradiated using a light irradiation machine with a sufficient amount of light 13 to cure the adhesive layer 1a. In the case of ultraviolet light irradiation, the amount of irradiation may be about 400 mJ/cm² or more. In this step, the adhesive layer 1a is cured to form the resin film 1. Thus, the composite film 10 of this embodiment is produced.

When the composite film 10 is used, as shown in FIG. 4(d) the third release liner 9 for light release is removed, and the composite film 10 is attached to an adherend, and thereafter, the first release liner 5 for heavy release is removed.

In the foregoing, the embodiments for carrying out the present invention have been described, and the present invention is not limited to the above embodiments. Various changes and modifications can be made to the present invention without departing the scope and spirit of the present invention.

### Examples

-Production of Composite Film-

<Preparation of Adhesive Compositions 1-6>

Initially, 2.0 parts by mass, 4.0 parts by mass, 6.0 parts by mass, and 8.0 parts by mass of a toluene diisocyanate (TDI)-trimethyl propane (TMP) adduct as a curing agent, and 1.2 parts by mass, 1.2 parts by mass, 1.7 parts by mass, and 1.7 parts by mass, respectively, of α-hydroxyalkylphenone (“Omnirad 184,” manufactured by iGM) as a photopolymerization initiator, were added to 100 parts by mass of a commercially available UV-curable adhesive agent A (main agent) to prepare adhesive compositions 1-4, respectively. The adhesive agent A contained an acrylic polymer and a vinyl ester as a solid content, and a solvent such as toluene. Table 1 shows the compositions of the adhesive compositions.

TABLE 1

| | Main agent | | | | |
|---|---|---|---|---|---|
| | | Solid | | | |
| Name of film | | content | Curing agent/added | Photopolymerization initiator/added | |
| material | Adhesive agent | (parts) | amount | amount | Remarks |
| Composition 1 | Adhesive agent A | 40.0 | TDI-TMP/2.0 parts | α-hydroxyalkylphenone/1.2 parts | UV exposure |
| | (UV curable type) | | | | amount: 400 |
| | | | | | mJ/cm² |
| Composition 2 | Adhesive agent A | 40.0 | TDI-TMP/4.0 parts | α-hydroxyalkylphenone/1.2 parts | UV exposure |
| | (UV curable type) | | | | amount: 400 |
| | | | | | mJ/cm² |
| Composition 3 | Adhesive agent A | 40.0 | TDI-TMP/6.0 parts | α-hydroxyalkylphenone/1.7 parts | UV exposure |
| | (UV curable type) | | | | amount: 400 |
| | | | | | mJ/cm² |
| Composition 4 | Adhesive agent A | 40.0 | TDI-TMP/8.0 parts | α-hydroxyalkylphenone/1.7 parts | UV exposure |
| | (UV curable type) | | | | amount: 400 |
| | | | | | mJ/cm² |
| Composition 5 | Adhesive agent B | 38.0 | Urethane curing | 1-hydroxycyclohexylphenylketone/ | UV exposure |
| | (UV curable type) | | agent/0.14 parts | 0.06 parts | amount: 1000 |
| | | | | | mJ/cm² |
| PP | — | — | — | — | OPP film |
| | | | | | Film thickness: 20 |
| | | | | | μm |
| Composition 6 | Adhesive agent C | 30.0 | Epoxy curing | — | Acrylic adhesive |
| | (Thermosetting | | agent/0.5 parts | | agent |
| | type) | | Metal chelate | | |
| | | | compound/0.5 parts | | |

In addition, 0.14 parts by mass of a urethane curing agent, and 0.06 parts by mass of 1-hydroxycyclohexylphenylketone (“CK-938,” manufactured by Nippon Carbide Industries Co., Inc.) as a photopolymerization initiator, were added to 100 parts by mass of a commercially available ultraviolet-curable acrylic adhesive agent B (main agent) to prepare an adhesive composition 5. An adhesive film having an adhesive layer was produced using the adhesive composition 5.

Next, an epoxy curing agent and a metal chelate compound were added to a commercially available thermosetting acrylic adhesive agent C (“LKG-1012,” manufactured by Fujikura Kasei Co., Ltd.) to prepare an adhesive composition 6. An adhesive film having an adhesive layer was produced using the adhesive composition 6.

### Examples 1 and 2

The adhesive compositions 1 and 4 were each used to produce an adhesive film in which the adhesive layer subsequently had a film thickness of 10 μm after being dried. Next, by the steps shown in FIGS. 4(a)-4(c), composite films were produced using these adhesive films and solid particles A having an average particle size of 50 μm. A hot pressing step was performed using a hot pressing machine under conditions that the temperature was 120° C., the pressure was 2 MPa/cm², and the duration was 5 minutes. After the hot pressing, the adhesive layer was cured by irradiation with ultraviolet light (UV) of 400 mJ/cm². Here, the solid particles A were an electrically conductive particle obtained by forming nickel plating and gold plating in this order on the surface of a spherical resin.

Assessment was conducted using an assessment technique described below. The assessment demonstrated that in both of the composite films of Examples 1 and 2, the particles were exposed from the first surface (upper surface) and the second surface (lower surface). Both of the composite films of Examples 1 and 2 also had an electrical conductivity of 1-10 Ω. In Example 2, the packing density was 60.4%. In both of the films of Examples 1 and 2, no shrinkage was observed, and the handling properties were excellent.

### Examples 3-5

The adhesive compositions 1, 2, and 4 were each used to produce an adhesive film in which the adhesive layer subsequently had a film thickness of 15 μm after being dried. Next, by steps similar to those of Examples 1 and 2, composite films were produced using these adhesive films and the solid particles A having an average particle size of 50 μm.

In all of the composite films of Examples 3-5, the particles were exposed from the first and second surfaces. All of the composite films of Examples 3-5 also had an electrical conductivity of 1-10 Ω. In Example 5, the packing density was 61.2%. In all of the films of Examples 3-5, no shrinkage was observed, and the handling properties were excellent.

### Examples 6-8>

The adhesive compositions 1, 2, and 4 were each used to produce an adhesive film in which the adhesive layer subsequently had a film thickness of 20 μm after being dried. Next, by steps similar to those of Examples 1 and 2, composite films were produced using these adhesive films and the solid particles A having an average particle size of 50 μm.

In all of the composite films of Examples 6-8, the particles were exposed from the first and second surfaces. All of the composite films of Examples 6-8 also had an electrical conductivity of 1-10 Ω. In Example 7, the packing density was 58.1%. In Example 8, the packing density was 55.7%. In all of the films of Examples 6-8, no shrinkage was observed, and the handling properties were excellent.

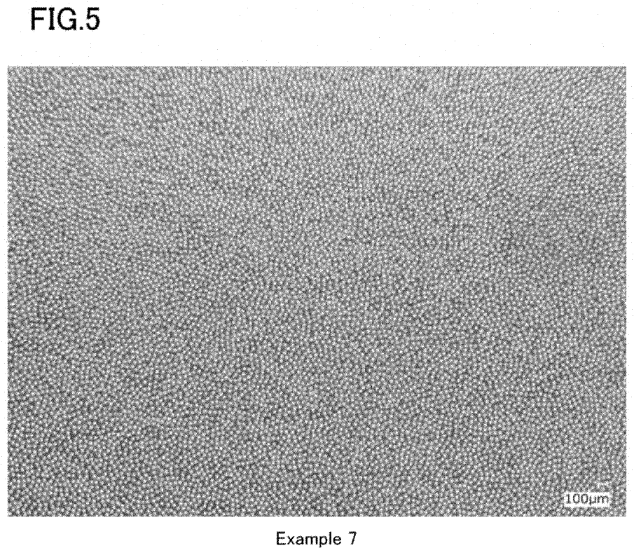

As shown in FIG. 5, on the adhesive layer before hot pressing, the solid particles A were held in almost a single layer and at a high density.

### Example 9

The adhesive composition 5 was used to produce an adhesive film in which the adhesive layer subsequently had a film thickness of 20 μm after being dried. Next, by steps similar to those of Examples 1 and 2, a composite film was produced using the adhesive film and the solid particles A having an average particle size of 50 μm. Note that after hot pressing, the adhesive layer was cured by irradiation with ultraviolet light (UV) of 1000 mJ/cm².

In the composite film of Example 9, the particles were exposed from the first and second surfaces. The composite film of Example 9 also had an electrical conductivity of 1-10 Ω. In Example 9, the packing density was 55.0%. In Example 9, a slight shrinkage of the film was observed, but the easiness of use thereof was not affected, and the handling properties were good.

### Examples 10 and 11

The adhesive compositions 1 and 4 were each used to produce an adhesive film in which the adhesive layer subsequently had a film thickness of 10 μm after being dried. Next, by steps similar to those of Examples 1 and 2, composite films were produced using these adhesive films and solid particles B having an average particle size of 30 μm. The solid particles B were an electrically conductive particle obtained by covering the surface of a spherical resin having a diameter of about 30 μm with nickel plating.

In both of the composite films of Examples 10 and 11, the particles were exposed from the first and second surfaces. In Example 10, the packing density was 59.7%. In Example 11, the packing density was 55.7%. In both of the films of Examples 10 and 11, no shrinkage was observed, and the handling properties were excellent.

### Comparative Example 1

The adhesive composition 6 was used to produce an adhesive film in which the adhesive layer subsequently had a film thickness of 10 μm after being dried. Next, the solid particles A having an average particle size of 50 μm were distributed and placed on the adhesive layer, and thereafter, hot pressing was performed under the same conditions as those of Examples 1 and 2, to produce a composite film. The adhesive layer had been cured before the hot pressing, and therefore, UV irradiation was not performed.

In the composite film of Comparative Example 1, the particles were exposed from the first and second surfaces. The composite film of Comparative Example 1 also had an electrical conductivity of 1-10 Ω. In Comparative Example 1, the packing density was 60.4%. In Comparative Example 1, the film significantly shrank and had poor handling properties.

### Comparative Example 2

The solid particles A were distributed and placed on a biaxially-stretched polypropylene film (OPP film) having a film thickness of 20 μm. and thereafter, hot pressing was performed under the same conditions as those of Examples 1 and 2. In Comparative Example 2, the packing density was 17.3-39.3%. However, the solid particles A were only present on the surface of the OPP film, and were not buried in the film.

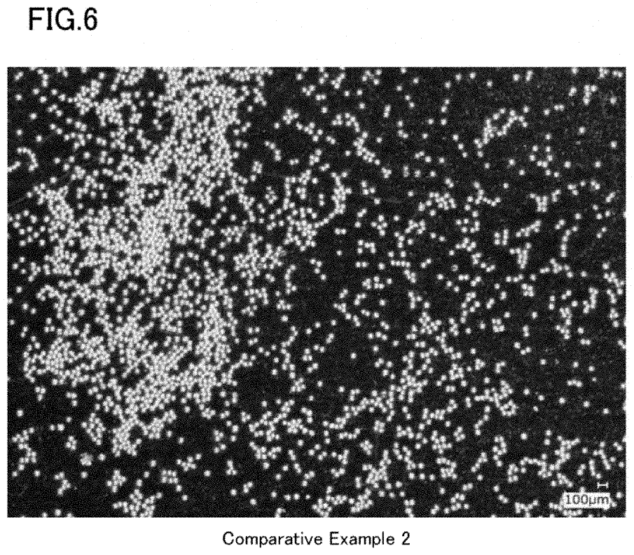

Note that as shown in FIG. 6, the OPP film does not have tackiness, and therefore, only a small number of solid particles A were placed on the OPP film before hot pressing, compared to Example 7.

### Comparative Example 3

The adhesive composition 1 was used to produce an adhesive film in which the adhesive layer subsequently had a film thickness of 25 μm after being dried. Next, by steps similar to those of Examples 1 and 2, a composite film was produced using the adhesive film and the solid particles A having an average particle size of 50 μm.

In the composite film of Comparative Example 3, the particles were exposed from the first surface, and not from the second surface. Because the particles were not exposed from the second surface, electrical conductivity was not able to be measured. In Comparative Example 3, no shrinkage of the film was observed, and the handling properties were excellent.

### Comparative Example 4

The adhesive composition 1 was used to produce an adhesive film in which the adhesive layer subsequently had a film thickness of 30 μm after being dried. Next, by steps similar to those of Examples 1 and 2, a composite film was produced using the adhesive film and the solid particles A having an average particle size of 50 μm.

In the composite film of Comparative Example 4, the particles were exposed from the first surface, and not from the second surface. Because the particles were not exposed from the second surface, electrical conductivity was not able to be measured. In Comparative Example 4, no shrinkage of the film was observed, and the handling properties were excellent.

### Comparative Examples 5 and 6

The adhesive compositions 1 and 4 were each used to produce an adhesive film in which the adhesive layer subsequently had a film thickness of 15 μm after being dried. Next, by steps similar to those of Examples 1 and 2, composite films were produced using these adhesive films and the solid particles B.

In both of the composite films of Comparative Examples 5 and 6, the particles were exposed from the first surface, and only a portion of the particles were exposed from the second surface. In Comparative Example 5, the packing density was 55.7%. In Comparative Example 6, the packing density was 52.6%. In both of Comparative Examples 5 and 6, no shrinkage of the film was observed, and the handling properties were excellent.

### Comparative Examples 7 and 8

The adhesive compositions 1 and 4 were each used to produce an adhesive film in which the adhesive layer subsequently had a film thickness of 20 μm after being dried. Next, by steps similar to those of Examples 1 and 2, composite films were produced using these adhesive films and the solid particles B.

In both of the composite films of Comparative Examples 7 and 8, the particles were not exposed from the first or second surface. In Comparative Example 7, the packing density was 52.6%. In Comparative Example 8, the packing density was 50.2%. In both of Comparative Examples 7 and 8, no shrinkage was observed, and the handling properties were excellent.

### Comparative Examples 9 and 10

The adhesive composition 1 was used to produce adhesive films in which the adhesive layer subsequently had a film thickness of 25 μm and 35 μm, respectively, after being dried. Next, by steps similar to those of Examples 1 and 2, composite films were produced using these adhesive films and the solid particles B.

In both of the composite films of Comparative Examples 9 and 10, the particles were not exposed from the first or second surface. In Comparative Example 9, the packing density was 44.7%. In Comparative Example 10, the packing density was 36.1%. In both of Comparative Examples 9 and 10, no shrinkage was observed, and the handling properties were excellent.

-Observation and Measurement Techniques of Composite Film-

<Assessment Technique of Exposed State of Solid Particles>

The third and first release liners were removed from the composite films produced in the above examples and comparative examples, and the presence or absence of gloss of the opposite surfaces was visually checked. It was determined that a surface that lost gloss had exposed solid particles. In addition, the composite film was cut along the film thickness direction, and the cross- section was observed using an optical microscope, whereby the presence or absence of exposure of the solid particles was determined.

The composite film from which the release liners had been removed was sandwiched between a positive electrode plate and a negative electrode plate, and in this state, a predetermined voltage was applied between the two electrodes using a tester (a pocket-sized tester “CDM-03D,” manufactured by Custom Corporation), to measure and determine whether or not the composite film was electrically conductive. Because both of the solid particles A and B are electrically conductive, when a current flowed between the positive and negative electrode plates, it was determined that the solid particles were exposed from the opposite surfaces of the resin film. When a current did not flow between the positive and negative electrode plates, it was determined that the solid particles were not exposed or were insufficiently exposed from at least one surface.

<Measurement Technique of Storage Modulus (G′)>

For the adhesive compositions 1-6 shown in Table 1, the storage modulus was measured at 23° C., 100° C., and 120° C. before and after UV irradiation. Specifically, the adhesive compositions 1-6 were each applied to a film made of a polyester, and the solvent was volatilized, to form an adhesive layer, and a circular test piece having a diameter of 8 mm was cut out from the adhesive layer. The test piece thus obtained was fixed to a parallel plate having a diameter of 8 mm using an epoxy resin, to which a plate having a diameter of 25 mm or less was tightly attached, and the storage modulus of the adhesive layer was measured. The adhesive layer had a thickness of about 1 mm. For the measurement, a rheometer (“AR2000ex,” manufactured by TA Instruments, Inc.) was used. The measurement was performed under the following conditions: the measurement temperature was −40° C. to 160° C.; the temperature increase rate was 3° C./min; the strain was 0.05%; and the frequency was 1 Hz.

<Probe Tack>

The adhesive compositions 1-4 shown in Table 1 were used to produce adhesive films in which the adhesive layer subsequently had a film thickness of 10 μm, 15 μm, 20 μm, and 25 μm, respectively, after being dried, and a test piece having a width of 20 mm and a length of 20 mm was cut out from each adhesive film. A test piece having the same size as that of those adhesive films was cut out from an OPP film having a film thickness of 20 μm. Next, in an atmosphere of 23° C. and 50% RH, a release sheet was removed from each test piece, and the probe tack of the exposed surface of the adhesive layer was measured. The test piece of the OPP film was directly tested on its probe tack. A stainless probe having a diameter (ϕ) of 5 mm was in contact with the surface of the adhesive layer at a contact load of 1.5 N/cm² for 1 second, and thereafter, the probe was moved away from the surface at a speed of 5 cm/sec. At this time, the release strength of the probe was measured. The measurement was performed 10 times, and the average value of eight measurement results excluding the highest and lowest results was calculated.

<Determination of Easiness of Handling of Composite Film>

The third release liner for light release was removed from the composite films produced in the above examples and comparative examples, and in this state, the degree of shrinkage of the film was visually checked. If no shrinkage of the film was observed, the handling properties were determined to be “excellent.” If a partial shrinkage of the film was observed, but easiness of use was not affected, the handling properties were determined to be “good.” If a significant shrinkage was observed, the handling properties were determined to be “poor.”

<Technique of Calculating Packing Density of Solid Particles>

The composite films produced in the above examples and comparative examples were each magnified by a factor of 500 using an optical microscope, and the solid particles contained in the composite film in a predetermined area were counted. Since both of the solid particles A and B had very small variations in particle size, the packing density of the solid particles in the composite film was calculated, assuming that the area occupied by a solid particle having a diameter of D was πD²/4.

<Measurement and Observation Results>

The measurement results of the storage moduli of the adhesive compositions 1-6 before and after UV irradiation were shown in Table 2. The measurement results of the adhesive layers produced using the adhesive compositions 1-4 before and after UV irradiation are shown in Table 3. Note that hatched cells in Tables 2 and 3 indicate no measurement.

TABLE 2

| | Storage moduli G’ (Pa) | | | | | |
|---|---|---|---|---|---|---|
| | Before UV irradiation | | | After UV irradiation | | |
| Name of film material | 23° C. | 100° C. | 120° C. | 23° C. | 100° C. | 120° C. |
| Composition 1 | 1.1 × 10⁵ | 1.3 × 10⁴ | 1.0 × 10⁴ | 4.3 × 10⁷ | 1.8 × 10⁷ | 1.6 × 10⁷ |
| Composition 2 | 1.8 × 10⁵ | 3.1 × 10⁴ | 2.8 × 10⁴ | 7.3 × 10⁷ | 8.9 × 10⁶ | 6.8 × 10⁶ |
| Composition 3 | 1.8 × 10⁵ | 3.8 × 10⁴ | 3.4 × 10⁴ | 1.2 × 10⁸ | 3.7 × 10⁷ | 3.3 × 10⁷ |
| Composition 4 | 2.8 × 10⁵ | 6.2 × 10⁴ | 5.7 × 10⁴ | 1.2 × 10⁸ | 1.6 × 10⁷ | 1.2 × 10⁷ |
| Composition 5 | 1.5 × 10⁵ | 5.2 × 10⁴ | | 2.7 × 10⁵ | 9.2 × 10⁴ | |
| PP | — | — | — | | | |
| Composition 6 | 5.8 × 10⁵ | 1.4 × 10⁵ | 1.1 × 10⁵ | | | |

TABLE 3

| Name of | Probe tacks (N/cm²) | | | | | | | |
|---|---|---|---|---|---|---|---|---|
| film | Before UV irradiation | | | | After UV irradiation | | | |
| material | 10 μm | 15 μm | 20 μm | 25 μm | 10 μm | 15 μm | 20 μm | 25 μm |
| Comp- | | 9.70 | 17.3 | 17.5 | 0 | 0 | 0 | 0 |
| osition 1 | | | | | | | | |
| Comp- | 4.55 | 6.90 | 10.0 | | 0 | 0 | 0 | |
| osition 2 | | | | | | | | |
| Comp- | | 5.20 | | | 0 | 0 | | |
| osition 3 | | | | | | | | |
| Comp- | 3.45 | 5.00 | 7.25 | | 0 | 0 | | |
| osition 4 | | | | | | | | |
| PP | — | — | 0 | — | 0 | 0 | | |

The measurement and assessment results of the composite films produced in Examples 1-9 and Comparative Examples 1-4 are shown in Table 4. The measurement and assessment results of the composite film produced in Examples 10 and 11 and Comparative Examples 5-10 are shown in Table 5.

TABLE 4

| | | Solid particles A (average particle size: 50μm) | | | | | |
|---|---|---|---|---|---|---|---|
| | Resin film | Name of film | Exposed states of particles | | Conductivity | Packing | Handling |
| | thickness (μm) | material | First surface | Second surface | (Ω) | density (%) | properties |
| Example 1 | 10 | Composition 1 | Exposed | Exposed | 1-10 | | Excellent |
| Example 2 | | Composition 4 | Exposed | Exposed | 1-10 | 60.4 | Excellent |
| Comparative | | Composition 6 | Exposed | Exposed | 1-10 | 60.4 | Poor |
| Example 1 | | | | | | | |
| Example 3 | 15 | Composition 1 | Exposed | Exposed | 1-10 | | Excellent |
| Example 4 | | Composition 2 | Exposed | Exposed | 1-10 | | Excellent |
| Example 5 | | Composition 4 | Exposed | Exposed | 1-10 | 61.2 | Excellent |
| Example 6 | 20 | Composition 1 | Exposed | Exposed | 1-10 | | Excellent |
| Example 7 | | Composition 2 | Exposed | Exposed | 1-10 | 58.1 | Excellent |
| Example 8 | | Composition 4 | Exposed | Exposed | 1-10 | 55.7 | Excellent |
| Example 9 | | Composition 5 | Exposed | Exposed | 1-10 | 55.0 | Good |
| Comparative | | PP | | | | 17.3-39.3 | Not buried |
| Example 2 | | | | | | | |
| Comparative | 25 | Composition 1 | | Exposed | Not exposed | Not | Excellent |
| Example 3 | | | | | | measurable | |
| Comparative | 30 | Composition 1 | | Exposed | Not exposed | Not | Excellent |
| Example 4 | | | | | | measurable | |

| | | | Solid particles B (average particle size: 30 μm) | | | | |
|---|---|---|---|---|---|---|---|
| | Resin film | Name of film | Exposed states of particles | | Conductivity | Packing | Handling |
| | thickness (μm) | material | First surface | Second surface | (Ω) | density (%) | properties |
| Example 10 | 10 | Composition 1 | Exposed | Exposed | | 59.7 | Excellent |
| Example 11 | | Composition 4 | Exposed | Exposed | | 55.7 | Excellent |
| Comparative | 15 | Composition 1 | Exposed | Partially exposed | | 55.7 | Excellent |
| Example 5 | | | | | | | |
| Comparative | | Composition 4 | Not exposed | Partially exposed | | 52.6 | Excellent |
| Example 6 | | | | | | | |
| Comparative | 20 | Composition 1 | Not exposed | Not exposed | | 52.6 | Excellent |
| Example7 | | | | | | | |
| Comparative | | Composition 4 | Not exposed | Not exposed | | 50.2 | Excellent |
| Example 8 | | | | | | | |
| Comparative | 25 | Composition 1 | Not exposed | Not exposed | | 44.7 | Excellent |
| Example 9 | | | | | | | |
| Comparative | 30 | Composition 1 | Not exposed | Not exposed | | 36.1 | Excellent |
| Example 10 | | | | | | | |

Firstly, the results of the adhesive compositions 1-4 shown in Tables 1 and 2 demonstrated that even in the case where the same adhesive agent was used as the main agent, the storage modulus at each temperature can be adjusted by changing the added amount of the curing agent.

As can be seen from Table 3, all of the adhesive compositions 1-6, which were used in the above examples and comparative examples excluding Comparative Example 2, had tackiness before UV curing. Therefore, it was confirmed that when solid particles are distributed on an adhesive layer, all of the adhesive compositions 1-6 can hold a single layer of the solid particles with a high density (see Example 7 shown in FIG. 5). As a result, as shown in Tables 4 and 5, it was confirmed that the packing density of solid particles is as high as 50% or more in Examples 2, 5, and 7-11, and Comparative Examples 5-8. Note that the results of Comparative Examples 5-10 shown in Table 5 demonstrated that as the film thickness of the adhesive layer increases with respect to the average particle size D of the solid particles, the packing density of the solid particles decreases. This may be because if the film thickness of the adhesive layer is excessively thick with respect to the average particle size of the solid particles, an extra portion of the adhesive layer is extended by pressing.

Meanwhile, in Comparative Example 2 in which an OPP film not having tackiness was used, as shown in FIG. 6 the density of the solid particles was low, and the solid particles were not uniformly distributed. Therefore, in Comparative Example 2, it was confirmed that the density of the solid particles was as low as 40% or less, and the density of the solid particles was significantly irregular.

In addition, comparison between the composite films produced in Examples 1-9 and Comparative Examples 3 and 4 shown in Table 4, and comparison between the composite films produced in Examples 10 and 11 and Comparative Examples 5-10 shown in Table 5, demonstrated that if the film thickness of the adhesive layer of an adhesive film used is 0.45 D or less with respect to the average particle size D of the solid particles, opposite ends of the solid particles can be exposed from the resin film.

In addition, in Examples 1-11 and Comparative Example 1, the solid particles were able to be exposed from the opposite surfaces of the resin film, which demonstrated that if the storage modulus of the adhesive layer at 120° C. before UV curing is 1×10² Pa to 1×10⁶ Pa, the solid particles are more easily pushed into the adhesive layer by hot pressing.

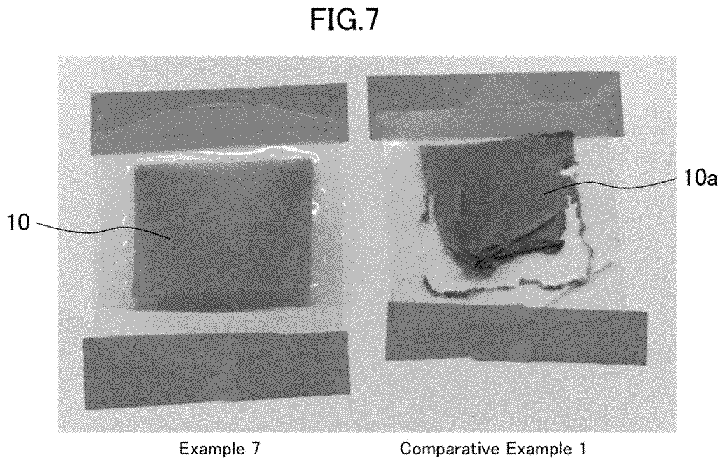

FIG. 7 is a photograph showing the composite film 10 (left side) of Example 7 after hot pressing, and the composite film 10a (right side) of Comparative Example 1 after hot pressing. FIG. 7 shows a state in which the first and third release liners were removed from the produced composite films.

As shown in FIG. 7, in the composite film 10 produced in Example 7, the adhesive layer was cured by UV irradiation after hot pressing, a shrinkage due to residual stress did not occur. In contrast to this, in the composite film 10a produced in Comparative Example 1, UV curing was not performed after hot pressing, and therefore, a significant shrinkage due to residual stress was observed.

While substantially no shrinkage occurred after hot pressing in the composite films produced in Examples 6-8, a relatively significant shrinkage was observed in the composite film produced in Example 9. Therefore, it was demonstrated that if the storage modulus of a resin film after UV irradiation is 1×10⁶ Pa or more at 23° C., the shrinkage of the resin film is more reliably reduced.

The composite film disclosed herein is used for production of, for example, an all-solid-state battery and an anisotropic electrically conductive film.

1-13. (canceled)

14. A method for producing a composite film, comprising:
a step of distributing and placing a single layer of solid particles on a first surface of an adhesive layer included in an adhesive film, the adhesive layer containing a photocurable pressure sensitive adhesive composition;
a step of pushing the solid particles into the adhesive layer by applying pressure and heat thereto with the first surface of the adhesive layer covered by a first release liner and a second surface opposite from the first surface of the adhesive layer covered by a second release liner; and
a step of curing the adhesive layer by irradiating the adhesive layer with light to form a resin film to which the solid particles are fixed with end portions of the solid particles exposed from the first and second surfaces,
wherein
the adhesive layer during the step of distributing the solid particles has a film thickness t of 0.45 D or less, where D represents an average particle size of the solid particles.

15. The method of claim 14, wherein
the adhesive layer has a storage modulus of 1×10² Pa to 1×10⁶ Pa at a frequency of 1 Hz at 120° C., and
the storage modulus of the resin film at a frequency of 1 Hz at 23° C. is greater than the storage modulus of the adhesive layer before curing at a frequency of 1 Hz at 23° C., and is 1×10⁵ Pa or more.

16. The method of claim 14, wherein
the value of (the total of the projection areas of the solid particles)/(the area of the resin film in a region where the solid particles are fixed) as viewed from above is 30-80%.

17. A composite film comprising:
a resin film formed of a cured product of a photocurable pressure sensitive adhesive composition; and
a single layer of solid particles fixed to the resin film and having end portions exposed from a first and a second surface of the resin film.

18. The composite film of claim 17, wherein the value of (the total of the projection areas of the solid particles)/(the area of the resin film in a region where the solid particles are fixed) as viewed from above is 30-80%.

19. The composite film of claim 17, wherein the value of (the total of the projection areas of the solid particles)/(the area of the resin film in a region where the solid particles are fixed) as viewed from above is 55-80%.

20. The composite film of claim 17, wherein the resin film has a storage modulus of 1×10⁵ Pa or more at a frequency of 1 Hz at 23° C.

21. The composite film of claim 17, wherein the resin film has a storage modulus of 1×10⁶ Pa or more at a frequency of 1 Hz at 23° C.

22. The composite film of claim 17, wherein the solid particles are a solid electrolyte particle having ion conductivity.

23. The composite film of claim 17, wherein the solid particles are an electrically conductive particle.

24. An all-solid-state battery comprising:
the composite film of claim 22;
a solid positive electrode layer provided on the first surface of the composite film and in contact with the solid particles; and
a solid negative electrode layer provided on the second surface of the composite film and in contact with the solid particles.

25. An adhesive film for use in the method of claim 14, comprising:
an adhesive layer configured to fix solid particles, the adhesive layer containing a photocurable pressure sensitive adhesive composition and not having a base material,
wherein
the adhesive layer, when irradiated with light, transitions from a first state to a second state, the storage modulus of the adhesive layer being higher in the second state than in the first state; and
the adhesive layer has a film thickness t of 0.45 D or less, where D represents an average particle size of the solid particles.

26. The adhesive film of claim 25, wherein
the adhesive agent layer in the first state has a storage modulus of 1×10² Pa to 1×10⁶ Pa at a frequency of 1 Hz at 120° C., and
the storage modulus of the adhesive layer in the second state at a frequency of 1 Hz at 23° C. is greater than the storage modulus of the adhesive layer in the first state at a frequency of 1 Hz at 23° C., and is 1×10⁵ Pa or more.
